(19) United States
(12) Patent Application Publication
(10) Pub. No.: US 2015/0302430 A1
(43) Pub. Date: Oct. 22, 2015

(54) YIELD OPTIMIZATION FOR PRODUCT BUNDLES

(71) Applicant: Tightrope Interactive, Inc., San Francisco, CA (US)

(72) Inventors: Franco Yuvienco, New York, NY (US); John Nguyen, San Francisco, CA (US)

(73) Assignee: TIGHTROPE INTERACTIVE, INC., San Francisco, CA (US)

(21) Appl. No.: 14/689,555

(22) Filed: Apr. 17, 2015

Related U.S. Application Data
(60) Provisional application No. 61/980,946, filed on Apr. 17, 2014.

(51) Int. Cl. G06Q 30/02

(52) U.S. Cl. CPC G06Q 30/0201

(57) ABSTRACT

Techniques for optimizing yield for product bundles are disclosed. Product presentation conditions and product information including product financial information is generated for a plurality of products. Products classified into different categories of the plurality of products are determined and added to a yield optimized product bundle. The products classified into different categories and added to the yield optimized product bundle are organized into a single product flow for the yield optimized product bundle based on the product financial information. It is determined whether to present the products in the yield optimized product bundle using the product presentation conditions in an order which is determined based on the product flow for the yield optimized product bundle.

### CROSS REFERENCE TO RELATED APPLICATIONS

This application claims priority to U.S. Provisional Application No. 61/980,946, filed Apr. 17, 2014, entitled “YIELD OPTIMIZATION FOR PRODUCT BUNDLES,” which is incorporated herein by reference.

### BACKGROUND

An area of ongoing research and development is the bundling of products together. Bundling of products is particularly important to software. Specifically, many types of software programs are designed to function with other types of software programs. Furthermore, as software can be easily purchased and used by being downloaded from a network, offering a number of software programs together through a bundled product can increase revenue as a requestor might be more inclined to download or purchase related software that is presented to them after downloading a specific software program.

As a result, software product bundles have been created that include software products and advertising software products. Product bundle creators have been formed to generate software product bundles and offer the software product bundles for other software producers or publishers. In organizing advertising products and generating an order in which they are presented to a requestor in interacting with the product bundle, product bundle developers classify advertising products into categories based on product type. Advertising products are ordered within advertising product categories from highest to lowest revenue per install. Categories of advertising products are then ordered based on the highest revenue per install product included in each category. For example, if advertising product category 1 has a product with a revenue per install of $2.00, advertising product category 2 has a product with a revenue per install of $1.00, and category 3 has a product with a revenue per install of $1.50, then the advertising product categories are ordered, based on the product with the highest revenue per install in the order of category 1, category 3, and category 2.

Typically, advertising products are presented to a requestor based, at least in part, on an order of categories of advertising products. For the previously mentioned example, products in category 1 are presented to a requestor before products in category 3, and products in category 3 are presented to a requestor before products in category 2. Further, advertising products are presented to a requestor based not only on an order of categories of advertising products but also based on conditions. Conditions can include whether a requestor's device meets the requirements, e.g. includes necessary applications or has necessary system requirements, for installing or executing an advertising product. In using conditions to display an advertising product to a requestor, it is determined whether or not conditions are met to present an advertising product in an advertising product category based on an order of the advertising products in the category. This continues until either all advertising products in an advertising product category are analyzed according to conditions to determine whether to present the advertising product, or it is found that none of the advertising products in the advertising product category meet the conditions for presentation of the product to a requestor. Then, if a product in the first advertising product category or no products in the first advertising product category are presented to a requestor, the method continues to a second advertising product category where it is determined whether to present an advertising product in the second advertising product category based on the order of the advertising products in the advertising products category and conditions. As a result, a number of distinct product flows are created, whereby each advertising product category and corresponding advertising products within each category make a distinct product flow in determining what advertising products to present to a requestor.

TABLE 1

| Toolbar | Shopping | Weather |
|---|---|---|
| Product 1A $2.00 | Product 2A $1.75 | Product 3A $1.00 |
| Product 1B $1.00 | Product 2B $1.50 | Product 3B $0.75 |
| Product 1C $0.50 | Product 2C $1.25 | Product 3C $0.50 |

With reference to an example advertising product classification illustrating products presented to a requestor in bold shown in FIG. 1, three products categories, toolbar, shopping, and weather are shown. The toolbar category includes three products, product 1A at $2.00 revenue per install, product 1B at $1.00 revenue per install, and product 1C at $0.50 revenue per install. The shopping category includes three products, product 2A at $1.75 revenue per install, product 2B at $1.50 revenue per install, and product 2C at $1.25 revenue per install. The weather category includes three products, product 3A at $1.00 revenue per install, product 3B at $0.75 revenue per install, and product 3C at $0.50 revenue per install. The product categories are ordered according to the highest revenue per install in each category, where the toolbar category is highest, the shopping category is the next highest, and the weather category is the least high. Further, advertising products are ordered in each advertising products category from highest to lowest in terms of revenue per install. In table 1, the products listed in bold are the products presented to a requestor of a product bundle according to the methods described in the preceding paragraphs. Specifically, product 1C is first presented to a requestor, then product 2A, and finally product 3B. This illustrated the problem with presenting advertising products according to the prior art method where distinct product flows for each advertising product category. Specifically, the first product presented, product 1C has lower revenue per install than the next two products shown to the requestor. There therefore exists a need for systems and methods of presenting advertising products to a requestor to optimize yield from product bundles.

Additionally, in determining which products to present to a requestor, the prior art methods and systems so not take into account the rate at which an advertising product is actually installed after being presented to a requestor. There therefore exists a need for systems and methods for presenting advertising products to requestors based, at least in part, on the rate that advertising products are installed after being presented to the requestors of a product bundle. Furthermore, as the rate at which advertising product after being presented to requestors of a product bundle can change in time, there therefore exists a need for systems and methods that respond to changes in the rate that advertising products are installed after being presented to requestors to optimize yield for product bundles.

Further, in determining which products to present to requestors for optimizing yield, the prior art methods and systems do not accommodate changes in payout rates to advertisers or entities associated with a product bundle, including entities associated with distributing a product bundle. There therefore exists a need for systems and methods for accommodating in changes in payout rates to advertisers or entities associated with a product bundle. Further, there exists a need for systems and methods for determining which advertising products to display in a product bundle to optimize yield for product bundles while accommodating for changes in payout values of advertisers or entities associated with a product bundle.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Various implementations include systems and methods for optimizing yield for product bundles. In various implementations, product presentation conditions and product information including product financial information is generated for a plurality of products. Further in various implementations, products classified into different categories of the plurality of products are determined and added to a yield optimized product bundle. In various implementations, product presentation conditions for the products are also added to the yield optimized product bundle. Additionally in various implementations, the products classified into different categories and added to the yield optimized product bundle are organized into a single product flow for the yield optimized product bundle based on the product financial information. In various implementations, it is determined whether to present the products in the yield optimized product bundle using the product presentation conditions in an order which is determined based on the product flow for the yield optimized product bundle.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for generating yield optimized product bundles.

FIG. 2 depicts a diagram of an example of a system for generating product information.

FIG. 3 depicts a diagram of an example of a system for generating yield optimized product bundles.

FIG. 4 depicts a diagram of a system for allowing a requestor to interact with a yield optimized product bundle.

FIG. 5 depicts a flowchart of an example of a method for generating a yield optimized product bundle and providing interaction with the yield optimized product bundle using product financial information.

FIG. 6 depicts a flowchart of an example of a method for generating a yield optimized product bundle and providing interaction with the yield optimized product bundle using amount of revenue generated per install for products.

FIG. 7 depicts a flowchart of an example of a method for generating a yield optimized product bundle and providing interaction with the yield optimized product bundle using amount of revenue generated per offer for products.

FIG. 8 depicts a flowchart of an example of a method for presenting products in a yield optimized product bundle to a requestor as the requestor interacts with the yield optimized product bundle.

FIG. 9 depicts a table of an example of installation trigger rules.

### DETAILED DESCRIPTION

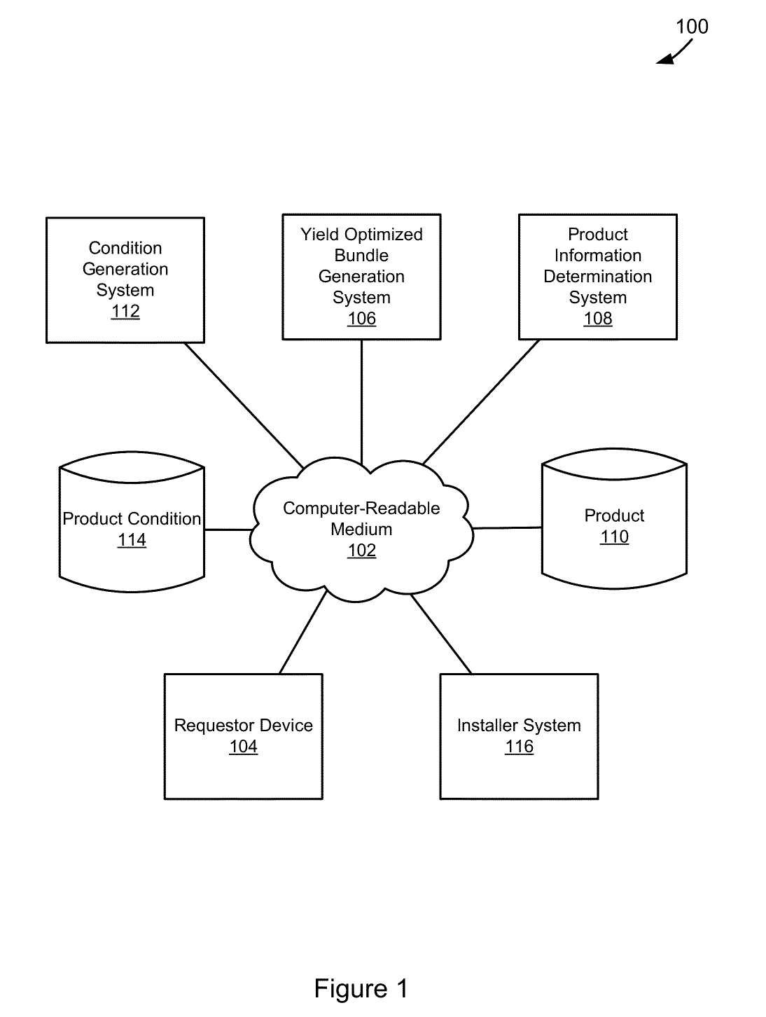

FIG. 1 depicts a diagram 100 of an example of a system for generating yield optimized product bundles. The system of the example of FIG. 1 includes a computer-readable medium 102, a requestor device 104, a yield optimized bundle generation system 106, a product information determination system 108, a product datastore 110, a condition generation system 112, a product condition datastore 114, and an installer system 116.

The requestor device 104, the yield optimized bundle generation system 106, the product information determination system 108, the product datastore 110, the condition generation system 112, the product condition datastore 114, and the installer system 116 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the requestor device 104, the yield optimized bundle generation system 106, the product information determination system 108, the condition generation system 112, and the flexible installer system 116 and other applicable systems, or devices described in this paper can be implemented as a computer system, a plurality of computer systems, or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Requestors can access the protocols of the cloud-based computing system through a web browser or other container application located on their client device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end requestors access through a web browser or container application without having the functionalities and/or modules installed locally on the end-requestors' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the requestor device 104 can be an applicable device through which a requestor can request a product and install products that are included in a yield optimized product bundle. The requestor device 104 can include a graphical user interface through which a requestor can interact with the yield optimized product bundle. Interacting with a yield optimized product bundle can include selecting and downloading products included as part of the yield optimized product bundle as the products are presented to a user of the requestor device 104. Depending upon implementation-specific or other considerations, the requestor device 104 can include a wireless interface through which the requestor device 104 can form a wireless connection to the computer-readable medium.

In a specific implementation, the yield optimized bundle generation system 106 functions to generate yield optimized product bundles. For example, the yield optimized bundle generation system 106 can add products to a yield optimized product bundle. In adding products to a yield optimized product bundle, the yield optimized bundle generation system 106 can add a product uniform resource locator (hereinafter referred to as “URL”) to a yield optimized product bundle. A product URL can provide a reference to a landing page in a network or the Internet from which a product, both primary and advertised, can be downloaded. Depending upon implementation-specific or other considerations, a product URL can be static in that it constantly provides a reference to a location for the same single product. As the product URL is static, if a new version of a product is created, the new version can be assigned to a different static product URL. As a result, a requestor can install a plurality of versions of a product that are included in a yield optimized product bundle. A product included in a yield optimized product bundle can be an application program that includes executable files and associated files. For example, the product can be Photoshop®. A product included in a yield optimized product bundle can be a data file associated with or parsed by a specific application program. For example, the product can be a “.pdf” data file.

In a specific implementation, in generating a yield optimized product bundle, the yield optimized bundle generation system 106 can add one or a plurality of primary products to the yield optimized product bundle. Depending upon implementation-specific or other considerations, a primary product included in a yield optimized product bundle can be a specific product that is requested by a requestor. Further depending upon implementation-specific or other considerations, a primary product included in a yield optimized product bundle can be a specific product that is popular to requestors. The popularity of the application program or data file can be based on the number of requestors that have requested to download the product. The popularity of the application program or data file can also be based on the number of requestors that are expected to download the product. A primary product can be a free product, e.g. an open source product, a paid-for product that requires payment before a requestor can use the product, or a trial version of a paid-for product, in which the requestor can interact with or use the product for a certain amount of time without paying.

In a specific implementation, in generating a yield optimized product bundle, the yield optimized bundle generation system 106 can add advertised products to the yield optimized product bundle. Advertised product can be products that are not specifically requested by a requestor of the requestor device 104. For example, advertised products can include toolbars, shopping related applications, or weather related applications.

In a specific implementation, the product information determination system 108 functions to generate product information about products. Product information generated by the product information determination system 108 can include product characteristics information. Product characteristics information generated by the product information determination system 108 can identify a producer of a product, a provider of a product, or a function or attributes of the product. For example, if a product is a video editor, then product characteristics information can include that the product is a media editor. Product characteristics information can also include a product URL.

In a specific implementation, product information generated by the product information determination system 108 includes product operational information. Product operational information can include minimum system requirements that are necessary to run or execute a product on a device. For example, if a specific operating system or web browser is necessary to execute a product on the requestor device 104, then the product operational information can indicate that the specific operating system or web browser needs to be available on the requestor device 104. In another example, if a specific amount of RAM needs to be available on the requestor device 104 in order to run the product, then the product operational information can include the specific amount of RAM necessary to run the program.

In a specific implementation, the product information determination system 108 functions to generate product information that includes product classification information. Product classification information can include categories in which products are classified. Categories that products are classified in can be specific to the type of products that are in the categories. For example, product classification information for a toolbar can indicate that the product is classified into the toolbar category. Depending upon implementation-specific or other considerations, in generating product classification information, the product information determination system 108 can classify products into categories, or receive categories that products are classified in from systems or entities separate from the product information determination system 108, e.g. a product supplier.

In a specific implementation, the product information determination system 108 functions to generate product information that includes product financial information. Product financial information generated by the product information determination system 108 can include an amount of revenue that is generated per install of a product for entities associated with a product bundle. Entities associated with a product bundle can include product bundle creators, product developers and suppliers, and product bundle distributors and advertisers. In generating product financial information that includes an amount of revenue that is generated per install, the product information determination system 108 can continuously update and generate product financial information for a product as variables that affect the amount of revenue per install of the product change. For example, as payout rates of distributors or advertisers of product bundles including a product change, the product information determination system can generate new product information that includes a new revenue per install value for the product that changed as a result of changing payout rates.

In a specific implementation, product financial information included as part of product information generated by the product information determination system 108 includes an amount of revenue that is generated per offer. As used in this paper, an amount of revenue generated per offer is the amount of revenue that is generated every time a product is presented to a requestor. An amount of revenue generated per offer of a product can be based on both an amount of revenue generated per install of the product and the acceptance rate to install the product when it is presented to a requestor interacting with a product bundle. An amount of revenue generated per offer can be calculated by multiplying revenue per install of a product by the rate at which the product is installed after being presented to a requestor. For example, if revenue per install of a product is $1.00 and the product is installed 50 out of 100 times that it is presented to a requestor, then an amount of revenue generated per offer of the product is $0.50. The product information determination system 108 can continuously update and generate product financial information for a product as variables that affect the amount of revenue per offer of the product change. For example, if a rate at which a product is installed after being presented to a requestor of a yield optimized product bundle changes, then the product information determination system 108 can generate new product financial information for the product that includes a new amount of revenue per offer value for the product. In another example, if a revenue per install of a product changes, i.e. payout rates of distributors or advertisers change, then the product information determination system 108 can generate new product financial information for the product that includes a new amount of revenue per offer value for the product. Depending upon implementation-specific or other considerations, in continuously updating product financial information, the product information determination system 108 can receive tracking data that includes a rate at which a product is installed after being presented to a requestor. Further depending upon implementation-specific or other considerations, in continuously updating product financial information, the product information determination system 108 can use applicable techniques for tracking the number of times a product is presented to requestors and the number of times it is installed.

In a specific implementation, the product datastore 110 functions to store product information. The product datastore 110 can store product information generated by the product information determination system 108. The product datastore 110 can store product information that can include product characteristics information, product operational information, product classification information, and product financial information. Product information for products can be stored based on categories in which products are classified. For example, products classified in the toolbar category can be stored in associated locations, or the same location in the product datastore 110.

In a specific implementation, the condition generation system 112 functions to generate product presentation conditions for presenting products to a requestor. Product presentation conditions include conditions that are used in determining whether to present a product within a yield optimized product bundle to a requestor of a requestor device interacting with the yield optimized product bundle. Depending upon implementation-specific or other considerations, product presentation conditions of a specific product can be conditions that must be met before the specific product is presented to a requestor interacting with a yield optimized product bundle that includes the specific product. Depending upon implementation-specific or other considerations, the condition generation system 112 can generate product presentation conditions based on input from an entity associated with a product, e.g. a developer of a product. For example, if input from a developer of products A and B specifies that product B should only be presented to a requestor if product A is downloaded, then the condition generation system 112 can generate a product presentation condition that specifies to present product B only if product A is downloaded.

In a specific implementation, the condition generation system 112 functions to generate installation trigger rules as part of product presentation conditions. Installation trigger rules are rules that serve as the basis for whether to trigger an action of performing a product installation process after one or a plurality of products are presented to a requestor or present another product to the requestor. Installation trigger rules can be generated based on requestors' behavioral conditions when interacting with a product bundle. Examples of behavioral conditions include whether a requestor accepts all products offered to them, whether a requestor declines all products offered to them, whether a requestor accepts one or a plurality of products offered to them and then declines a product offered to them, and whether a requestor declines one of a plurality of products offered to them and then accepts a product offered to them. Installation trigger rules can be formulated based on one or a plurality of the following conditions: whether a requestor has accepted a primary product, whether a requestor has accepted a specific product from a specific advertiser in a product bundle, whether a requestor accepts a maximum number of products, a maximum number of products a requestor can accept through a product bundle, whether a requestor has declined a maximum number of products, a maximum number of products a requestor can decline through a product bundle, whether a maximum number of products have been offered to a requestor through a product bundle, a maximum number of products a requestor can be offered through a product bundle, whether a requestor has accepted a specific number of products after declining a product, and whether a requestor has declined a specific number of products after accepting a product.

In a specific implementation, the condition generation system 112 can generate product presentation conditions based on product information generated by the product information determination system 108 and/or stored in the product datastore 110. Depending upon implementation-specific or other considerations, the condition generation system 112 can generate product presentation conditions based on classification information included as part of product information, generated by the product determination system 108 and/or stored in the product datastore 110. In using product classification information to generate product presentation conditions, the condition generation system 112 can generate product presentation conditions that specify to only present a product in a category if no other products in the same category have been presented. For example, if products A, B, and C are the only products classified in the same category, then the condition generation system 112 can generate product presentation conditions for products A, B, and C that specify to present products A, B, and C only if none of products A, B, and C have been presented to a requestor. Further in using product classification information to generate product presentation conditions, the condition generation system 112 can generate product presentation conditions that specify to only present a product in a category if another product in the category, or a specific product in the category has been presented to a requestor in interacting with a yield optimized product bundle. For example, the condition generation system 112 can generate a product presentation condition for product A that specifies only to display product A if product B, that has been classified in the same category as product A, is presented to a requestor interacting with a yield optimized product bundle.

In a specific implementation, the condition generation system 112 generates product presentation conditions for displaying a product to a requestor based, at least in part, on product operational information included as product information. Product operational information used to generate product presentation conditions by the condition generation system 112 can be generated by the product information determination system 108 and/or stored in the product datastore 110. For example, the condition generation system 112 can generate a product presentation condition that specifies to only present a product to a requestor if an application, e.g. specific web browser necessary to execute a product on the client device, is on or available to the client device. In another example, the condition generation system 112 can generate a product presentation condition that specifies to only present a product to a requestor if a maximum amount of RAM on a client device is greater than the amount of RAM necessary to execute the product.

In a specific implementation, the condition generation system 112 functions to continuously update product presentation conditions for products. In continuously updating product presentation conditions for products, the condition generation system 112 can change already existing product presentation conditions, create new product presentation conditions, and cancel already existing product presentation conditions. The condition generation system 112 can update product presentation conditions as product information is updated. For example, if product classification information is updated to add product B into a category that includes product A, then the condition generation system 112 can update product presentation conditions for product A to specify to only display product A if product B has not been displayer to a requestor.

In a specific implementation, the product condition datastore 114 functions to store product conditions. The product condition datastore 114 can store product presentation conditions that relate to the presentation of products to a requestor in interacting with a yield optimized product bundle. The product condition datastore 114 can store product presentation conditions generated by the condition generation system 112.

In a specific implementation, the yield optimized bundle generation system 106 functions to generate yield optimized product bundles using product information and product presentation conditions. Specifically, the yield optimized bundle generation system 106 can add products and product presentation conditions associated with the products to a yield optimized product bundle based on product information. In generating a yield optimized product bundle using product information, the yield optimized bundle generation system 106 can use product information generated by the product information determination system 108 and/or stored in the product datastore 110. For example, the yield optimized bundle generation system 106 can insert links to landing pages, included as product information, from where products included in a yield optimized product bundle can be downloaded. In generating a yield optimized product bundle using product presentation conditions, the yield optimized bundle generation system 106 can use product presentation conditions generated by the condition generation system 112 and/or stored in the product condition datastore 114.

In a specific implementation, in generating a yield optimized product bundle, the yield optimized bundle generation system 106 can create a product flow for the yield optimized product bundle. As used in this paper, a product flow is the order in which it is determined whether to present products in a yield optimized product bundle to a requestor in interacting with the yield optimized product bundle. In ordering products in a product flow, the yield optimized bundle generation system 106 can add products into first, second, etc. slots corresponding to their order in the product flow. For example, if product A is in a first slot of a product flow, product B is in a second slot after the first slot in the product flow, and product C is in a third slot after the second slot in the product flow, it is determined whether to present product A to a requestor first, then it is determined whether to present product B to the requestor, and then it is determined whether to present product C to the requestor.

In a specific implementation, the yield optimized bundle generation system generates a product flow for a yield optimized product bundle based on product information. Depending upon implementation-specific or other considerations, the yield optimized bundle generation system 106 generates a product flow for a yield optimized product bundle based on revenue generated per offer of products included in the yield optimized product bundle. The yield optimized bundle generation system 106 can generate a product flow that lists products in descending order from highest revenue generated per offer to lowest revenue generated per offer. For example, if product C generates $2.00 per offer, product A generates $1.00 per offer, and product B generates $0.50 per offer, then a product flow generated by the yield optimized bundle generation system 106 can have product C first, then product A, followed by product B. Further depending upon implementation-specific or other considerations, the yield optimized bundle generation system 106 generates a product flow for a yield optimized product bundle based on revenue generated per install of products included in the yield optimized product bundle. The yield optimized bundle generation system 106 can generate a product flow that lists products in descending order from highest revenue generated per install to lowest revenue generated per offer. For example, if product A generates $2.00 per install, product C generates $1.00 per install, and product B generates $0.50 per install, then a product flow created by the yield optimized bundle generation system 106 can have product A first, then product C, followed by product B.

In a specific implementation, the yield optimized bundle generation system 106 creates an order of products in a product flow independent of categories in which the products are classified. For example, if product A, B, and C are all in different categories, the yield optimized bundle generation system 106 can still place product A first in a product flow, then product B, followed by product C. In creating a product flow independent of categories that products are classified in, the yield optimized bundle generation system 106 creates a single product flow that includes products that are categorized into multiple categories. As result of creating a product flow independent of categories that products are classified in, the yield optimized bundle generation system can create a product flow that presents the products that generate the highest revenue per install or the highest revenue per offer. For example, if product B generates $2.00 per offer and product A generates $1.00 per offer, then the yield optimized bundle generation system 106 can create a product flow that specifies to present product B first and product A after product B.

In a specific implementation the installer system 116 functions to control a yield optimized product bundle as a client interacts with the product bundle. In various implementations, the installer system is integrated as part of the requestor device 104. The installer system 116 can function to determine what products to present to a requestor in interacting with a yield optimized product bundle and present products to the requestor while the requestor interacts with the yield optimized product bundle. In determining what products to present, the installer system 116 can use a product flow of a yield optimized product bundle and product presentation conditions of products included in the yield optimized product bundle. For example, the installer system 116 can determine whether product presentation conditions of a first product in a first slot in a product flow are met, and accordingly present or not present the first product to a requestor, and then determine whether product presentation conditions of a second product in a second slot in the product flow are met, and accordingly present or not present the second product to the requestor.

In an example of operation of the example system shown in FIG. 1, the product information determination system 108 generates product information. In the example of operation, the condition generation system generates product presentation condition that must be met in order to present a product to a requestor of the requestor device interacting with a yield optimized product bundle. Further in the example of operation, the yield optimized bundle generation system 106 can generate a yield optimized product bundle using product information and product presentation conditions. In the example of operation, in generated a yield optimized product bundle, the yield optimized bundle generation system 106 can create a product flow based on financial information of products, included as part of the product information. Additionally, in the example of operation, the installer system 116 functions to allow a requestor to interact with a yield optimized product bundle, by determining whether to present products included in the product flow based on product presentation conditions and the order of the products in the product flow.

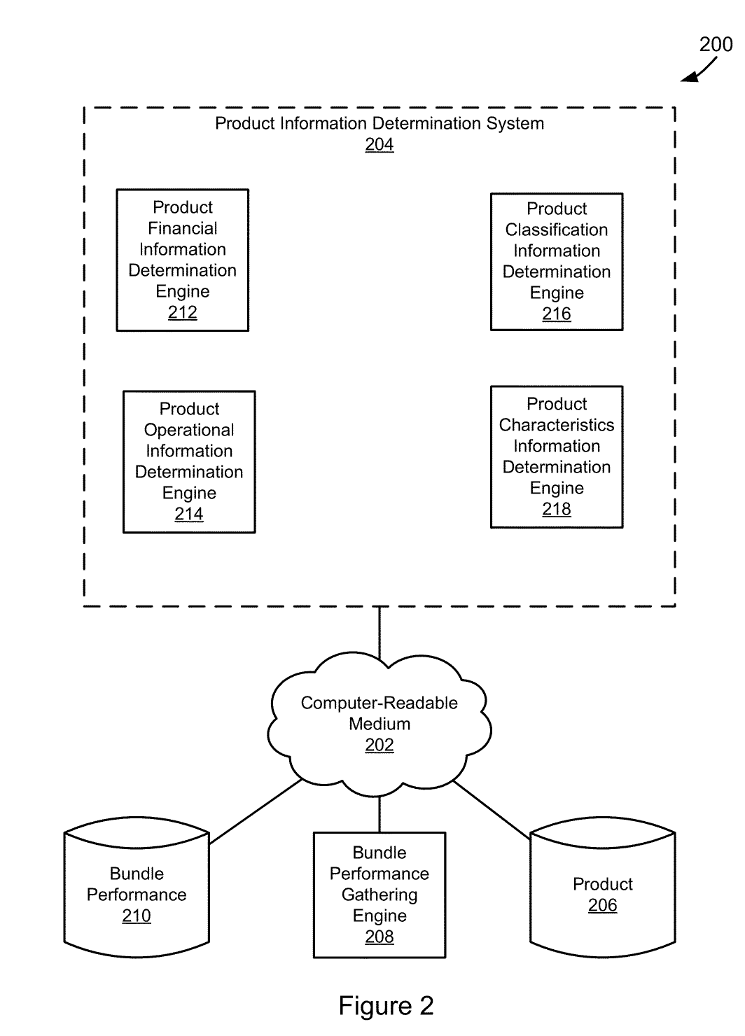

FIG. 2 depicts a diagram 200 of an example of a system for generating product information. The example system of FIG. 2 includes a computer-readable medium 202, a product information determination system 204, a product datastore 206, a bundle performance gathering engine 208, and a bundle performance datastore 210. In the example system shown in FIG. 2, the product information determination system 204, the product datastore 206, the bundle performance gathering engine 208, and the bundle performance datastore 210 are coupled to each other through the computer-readable medium 202.

In a specific implementation, the product information determination system 204 functions according to an applicable system for generating product information, such as the product information determination systems described in this paper. The product information determination system 204 can generate product information for products included as part of yield optimized product bundle. Product information generated by the product information determination system 204 can include product characteristics information, product operational information, product classification information, and/or product financial information.

In a specific implementation, the product datastore 206 functions according to an applicable datastore for storing product information, such as the product datastores described in this paper. The product datastore 206 can store product information generated by the product information determination system 204.

In a specific implementation, the bundle performance gathering engine 208 functions to gather bundle performance data for a yield optimized product bundle. Bundle performance data for a yield optimized product bundle can include what products in the yield optimized product bundle were presented to a requestor interacting with the yield optimized product bundle and what products in the yield optimized product bundle that were presented to the requestor were actually downloaded. Bundle performance data for a yield optimized product bundle can also include a time at which a requestor begins or continues interacting with the yield optimized product bundle and the location of the requestor interacting with the yield optimized product bundle. Depending upon implementation-specific or other considerations, the bundle performance gathering engine 208 can use applicable systems and methods for tracking yield optimized product bundles to gather bundle performance data. Further depending upon implementation-specific or other considerations, in gathering bundle performance data for a yield optimized product bundle the bundle performance gathering engine 208 can receive bundle performance data from an applicable system for managing and controlling requestor interaction with the yield optimized product bundle, e.g. the installer systems described in this paper.

In a specific implementation, the bundle performance datastore 210 stored bundle performance data. The bundle performance datastore 210 can store bundle performance data that is gathered by the bundle performance gathering engine 208. Bundle performance data stored in the bundle performance datastore 210 can be used to generate product information that includes revenue a product generates per offer.

In the example system shown in FIG. 2, the product information determination system 204 includes a product financial information determination engine 212, a product operational information determination engine 214, a product classification information determination engine 216, and a product characteristics information determination engine 218. In a specific implementation, the product financial information determination engine 212 functions to generate product financial information for products included in a yield optimized product bundle. In generating product financial information, the product financial information determination engine 212 can use bundle performance data gathered by the bundle performance gathering engine 208 and/or stored in the bundle performance datastore 210. Further in generating product financial information, the product financial information determination engine 212 can use input received from entities associated with a product bundle. For example, the product financial information determination engine 212 can receive input regarding payout rates of product bundle advertisers and distributors, from a product bundle creator and use the input to generate product financial information.

In a specific implementation, the product financial information determination engine 212 can determine amount of revenue generated per install of a product that can be included in a yield optimized product bundle. In determining an amount of revenue generated per install of products, the product financial information determination engine 212 can use input received for entities associated with a product bundle. For example, the product financial information determination engine 212 can receive input that includes payout rates of advertisers or distributors of yield optimized product bundles to determine an amount of revenue generated per install of a product. Depending upon implementation-specific or other considerations, the product financial information determination engine 212 can average the payout rates of advertisers of distributors of yield optimized product bundles that include a specific product to determine an amount of revenue generated per install of the specific product.

In a specific implementation, the product financial information determination engine 212 can determine an amount of revenue generated per offer of a product that can be included in a yield optimized product bundle. In determining an amount of revenue generation per offer of a product, the product financial information determination engine 212 can use bundle performance data gathered by the bundle performance gathering engine 208 and/or stored in the bundle performance datastore 210. For example, the product financial information determination engine 212 can determine a rate at which a product is downloaded when presented to a requestor in interacting with a yield optimized product bundle based on bundle performance data. For example, the product financial information determination engine 212 can determine the number of times a product is presented to requestors in interacting with yield optimized product bundles, and the number of times a product is downloaded by a requestor in interacting with the yield optimized product bundles to determine an acceptance rate at which the product is downloaded when presented to a requestor. In determining an amount of revenue generated per offer of a product, the product financial information determination engine 212 can use both a determined amount of revenue generated per install and a determined acceptance rate of a product. For example, the product financial information determination engine 212 can multiply an amount of revenue generated per install of a product by a rate of acceptance of the product to determine an amount of revenue generated per offer of the product.

In a specific implementation, the product financial information determination engine 212 generates and/or update product financial information continuously as products are included in yield optimized product bundles and are possibly presented to requestors interacting with the yield optimized product bundles. Further in the specific implementation, the product financial information determination engine 212 can generate and/or update product financial information as input from entities associated with a product bundle is received. For example, if input indicates changed payout rates of advertisers or distributors of a yield optimized product bundle, then the product financial information determination engine 212 can update and/or generate new product financial information based on the changed payout rates.

In a specific implementation, the product operational information determination engine 214 functions to generate product operational information of products that can be included in yield optimized product bundles. Depending upon implementation-specific or other considerations, the product operational information determination engine 214 can generate product operational information based on input received from entities associated with a product bundle. For example, the product operation information determination engine 214 can receive input that specifies web browsers that support execution of a product from a product developer, and generate product operational information that specifies the web browsers that support execution of the product. Further depending upon implementation-specific or other considerations, the product operational information determination engine 214 can determine product operational information for a product by executing the product on a test bed machine. For example, the product operation information determination engine 214 can execute a product on a test bed machine to determine the amount of RAM that is needed to execute the product.

In a specific implementation, the product classification information determination engine 216 functions to generate product classification information. Depending upon implementation-specific or other considerations, in generating product classification information, the product classification information determination engine 216 can classify products into categories. In classifying a product into a category, the product classification information determination engine 216 can use input received from entities associated with a product bundle. For example, the product classification information determination engine 216 can receive input from a product developer that identifies the characteristics of a product, and classify the product into a category based on the input. In classifying a product into a category, the product classification information determination engine 216 can use product information already generated for the product. For example, the product classification information determination engine 216 can use product characteristics information that specifies how a product functions or what the product functions to do to classify the product into a category. Further depending upon implementation-specific or other considerations, the product classification information determination engine can generate product classification information based on input received from entities associated with a product bundle. For example, the product classification information determination engine 216 can receive input from a developer of a product that identifies a category that the product is classified in, and generate product classification information for the product that identifies the category indicated by the input.

In a specific implementation, the product characteristics information determination engine 218 functions to generate product characteristics information for a product that can be included in a yield optimized product bundle. The product characteristics information determination engine 218 can generate product information based on input received from an entity associated with a product bundle. For example, the product characteristics information determination engine 218 can receive input from a product developer that specific a product URL that provides a link to a landing page from which the product can be downloaded. Further in the example, the product characteristics information determination engine 218 can use the input that specific the product URL to generate product characteristics information for the product that includes the product URL.

In an example of operation of the example system shown in FIG. 2, the bundle performance gathering engine 208 gathers bundle performance data for product bundles. In the example of operation of the example system shown in FIG. 2, the bundle performance datastore 210 stores bundle performance data gathered by the bundle performance gathering engine 208. Further in the example of operation of the example system shown in FIG. 2, the product financial information determination engine 212 generates product financial information for a product, that includes an amount of revenue generated per offer of a product, based, at least in part, on bundle performance data stored in the bundle performance datastore 210. In the example of operation of the example system shown in FIG. 2, the product operational information determination engine 214 generates product operational information for a product using, at least in part, input received from an entity associated with a product bundle. Additionally, in the example of operation of the example system shown in FIG. 2, the product classification information determination engine 216 generates product classification information by classifying a product into a category. In the example of operation of the example system shown in FIG. 2, the product characteristics information determination engine 218 generates product characteristics information for a product using, at least in part, input received from an entity associated with a product bundle. In the example of operation of the example system shown in FIG. 2, product information generated by the engines included as part of the product information determination system 204 is stored in the product datastore 206.

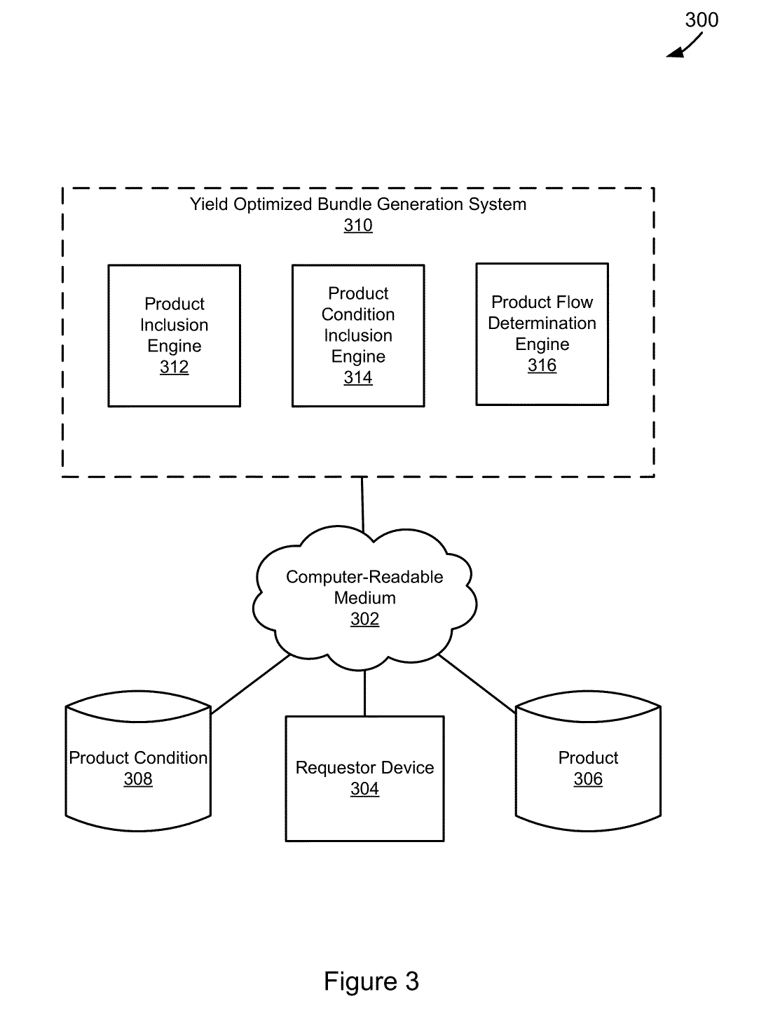

FIG. 3 depicts a diagram 300 of an example of a system for generating yield optimized product bundles. The example system shown in FIG. 3 includes a computer-readable medium 302, a requestor device 304, a product datastore 306, a product condition datastore 308, and a yield optimized bundle generation system 310. In the example system shown in FIG. 3, the requestor device 304, the product datastore 306, the product condition datastore 308, and the yield optimized bundle generation system 310 are coupled to each other through the computer-readable medium.

In a specific implementation, the requestor device 304 functions according to an applicable device for requesting a product to download, such as the requestor devices described in this paper. Further in the specific implementation, the requestor device 304 functions according to an applicable device through which a requestor can interact with a yield optimized product bundle, such as the requestor devices described in this paper. After generating a request to download a product, the requestor device 304 can receive a yield optimized product bundle or allow a requestor to begin interacting with a yield optimized product bundle that includes a product URL of the product that was requested by the requestor device 304.

In a specific implementation, the product datastore 306 functions according to an applicable datastore for storing product information, such as the product datastore described in this paper. The product datastore 306 can stored product information generated by an applicable system or engine for generating product information, such as the product information determination systems and engines included in the product information determination systems described in this paper. Product information stored in the product datastore 306 can include product characteristics information, product operational information, product classification information, and/or product financial information.

In a specific implementation, the product condition datastore 308 functions according to an applicable datastore for storing product presentation conditions, such as the product condition datastores described in this paper. The product condition datastore 308 can store product presentation conditions generated by an applicable system for generating product presentation conditions, such as the product condition generation systems described in this paper. Product presentation conditions stored in the product condition datastore 308 can include conditions used in determining whether to display a product in a yield optimized product bundle to a requestor interacting with the yield optimized product bundle.

In a specific implementation, the yield optimized bundle generation system 310 functions according to an applicable system for generating a yield optimized product bundle, such as the yield optimized bundle generation systems described in this paper. The yield optimized bundle generation system 310 can generate a yield optimized product bundle that includes a product that is requested by the requestor device 304 and serves as a primary product in the yield optimized product bundle. The yield optimized bundle generation system 310 can generate a yield optimized product bundle using product information, including product information stored in the product datastore 306. The yield optimized bundle generation system 310 can generate a yield optimized product bundle using product presentation conditions, including product presentation conditions stored in the product condition datastore 308.

In the example system shown in FIG. 3, the yield optimized bundle generation system 310 includes a product inclusion engine 312, a product condition inclusion engine 314, and a product flow determination engine 316. In a specific implementation, the product inclusion engine 312 functions to determine products to add to a yield optimized product bundle. In determining product to add to a yield optimized product bundle, the product inclusion engine 312 can determine to add products that are requested by the requestor device 304. For example, the product inclusion engine 312 can determine to add a product requested by the requestor device 304 to a yield optimized product bundle as a primary product.

In a specific implementation, the product inclusion engine 312 determines products to add to a yield optimized product bundle based on product information. The product inclusion engine 312 can determine products to add to a yield optimized product bundle using product financial information. Depending upon implementation-specific or other considerations, the product inclusion engine 312 can determine products to add to a yield optimized product bundle based on an amount of revenue generated per install of products. For example, the product inclusion engine 312 can determine to add products to a yield optimized product bundle that have the highest amount of revenue generated per install. Further depending upon implementation-specific or other considerations, the product inclusion engine 312 can determine products to add to a yield optimized product bundle based on an amount of revenue generated per offer of products. For example, the product inclusion engine 312 can determine to add products to a yield optimized product bundle that have the highest amount of revenue generated per offer. In determining products to add to a yield optimized product bundle based on an amount of revenue generated per install or an amount of revenue generated per offer, yield for a yield optimized product bundle can be increased or otherwise optimized to generate more revenue for various entities associated with a product bundle.

In a specific implementation, the product inclusion engine 312 functions to add products to a yield optimized product bundle and add products to the yield optimized product bundle. The product inclusion engine 312 can add products to a yield optimized product bundle that it determines to add to the yield optimized product bundle. In adding products to a yield optimized product bundle, the product inclusion engine 312 can include product URLs of products that it adds to the yield optimized product bundle.

In a specific implementation, the product condition inclusion engine 314 functions to add product presentation conditions to a yield optimized product bundle. In adding product presentation conditions to a yield optimized product bundle, the product condition inclusion engine 314 can retrieve product presentation conditions stored in the product condition datastore 308. The product condition inclusion engine 314 can retrieve product presentation conditions from the product condition datastore 308 for products that the product inclusion engine determines to add to a yield optimized product bundle. Depending upon implementation-specific or other considerations, the product condition inclusion engine 314 can add installation trigger rules, included as part of product presentation conditions to a yield optimized product bundle.

In a specific implementation, the product flow determination engine 316 functions to generate a product flow for a yield optimized product bundle. Depending upon implementation-specific or other considerations, the product flow determination engine 316 add a product requested by the requestor device 304 into a first slot of product flow, such that it is determined whether to present the product requested by the requestor device 304 first when a requestor begins interacting with a yield optimized product bundle. The product flow determination engine 316 can generate a product flow without regard to categories in which products are classified. As a result the product flow determination engine 316 can create a single distinct product flow that can include products from different categories.

In a specific implementation, in generating a product flow for a yield optimized product bundle, the product flow determination engine 316 can use product information of products that the product inclusion engine 312 determines to add to the yield optimized product bundle. Depending upon implementations-specific or other considerations, the product flow determination engine 316 can organized products to corresponding slots in a product flow based on an amount of revenue generated per install of the products. The product flow determination engine 316 can organize products to slots within a product bundle in descending order from the largest amount of revenue generated per install to the smallest amount of revenue generated per install. For example, if product A has a revenue per install of $2.00, product B has a revenue per install of $1.00, and product C has a revenue per install of $1.50, then the product flow determination engine 316 can add product A to a first slot in a product flow, product C to a second slot in the product flow, and product B into a third slot in the product flow. Further depending upon implementations-specific or other considerations, the product flow determination engine 316 can organize products to corresponding slots in a product flow based on an amount of revenue generated per offer of the products. The product flow determination engine 316 can organize products to slots within a product bundle in descending order from the largest amount of revenue generated per offer to the smallest amount of revenue generated per offer. For example, if product A has a revenue per offer of $2.00, product B has a revenue per offer of $1.00, and product C has a revenue per offer of $1.50, then the product flow determination engine 316 can add product A to a first slot in a product flow, product C to a second slot in the product flow, and product B into a third slot in the product flow.

In an example of operation of the example system shown in FIG. 3, product datastore 306 stores product information and the product condition datastore 308 stores product presentation conditions. In the example of operation of the example system shown in FIG. 3, the product inclusion engine 312 determines what products to add to a yield optimized product bundle and adds the product to the yield optimized product bundle based on product information stored in the product datastore 306. Further in the example of operation of the example system shown in FIG. 3, the product condition inclusion engine 314 determines product presentation conditions to add to a yield optimized product bundle based on the products that the product inclusion engine 312 determines to add to the yield optimized product bundle. In the example of operation of the example system shown in FIG. 3, the product flow determination engine 316 determines a product flow for a yield optimized product bundle based on product financial information of products added to the yield optimized product bundle. Additionally in the example of operation of the example system shown in FIG. 3, the product flow determination engine 316 determines a product flow without regard to categories in which the products are classified to create a single product flow that includes products classified in different categories.

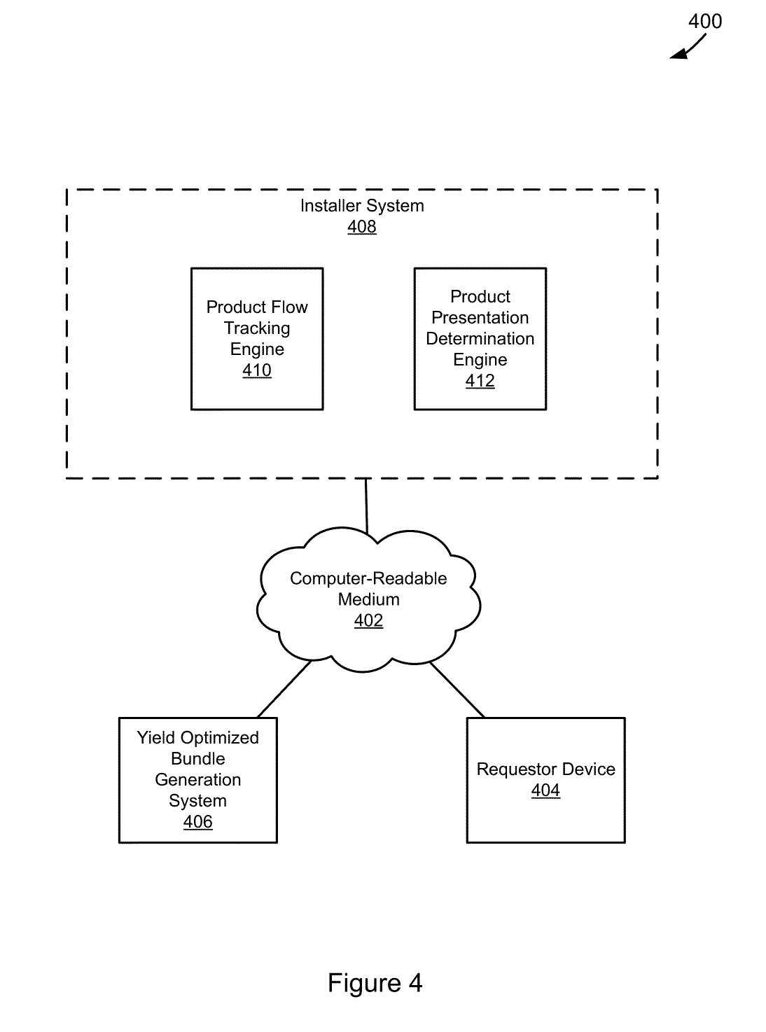

FIG. 4 depicts a diagram 400 of a system for allowing a requestor to interact with a yield optimized product bundle. The example system shown in FIG. 4 includes a computer-readable medium 402, a requestor device 404, a yield optimized bundle generation system 406, and an installer system 408. In the example system shown in FIG. 4, the requestor device 404, the yield optimized bundle generation system 406, and the installer system 408 are coupled to each other through the computer-readable medium 402.

In a specific implementation, the requestor device 404 functions according to an applicable device through which a requestor can interact with a yield optimized product bundle, such as the requestor devices described in this paper. In interacting with a yield optimized product bundle, the requestor device 404 can include a graphical user interface through which products can be presented to a requestor and the requestor can activate product URLs and download products included in a yield optimized product bundle.

In a specific implementation, the yield optimized bundle generation system 406 functions according to an applicable system for generating a yield optimized product bundle, such as the yield optimized bundle generation systems described in this paper. Depending upon implementation-specific or other considerations, the yield optimized bundle generation system 406 can generate a yield optimized product bundle in response to a request to download a product received from a requestor device 404. In generating a yield optimized product bundle, the yield optimized bundle generation system 406 can use product information, including product financial information. For example, the yield optimized bundle generation system 406 can use either or both an amount of revenue generated per install of a product and an amount of revenue generated per offer of a product to generate a yield optimized product bundle.

In a specific implementation, the installer system 408 functions according to an applicable system for allowing a requestor to interact with a yield optimized product bundle, such as the installer systems described in this paper. In various implementations, the installer system 408 or parts of the installer system 408 can be integrated as part of the requestor device 404 and executed on the requestor device 404. The installer system 408 can receive yield optimized product bundles generated by the yield optimized bundle generation system 406 to allow a requestor to interact with the yield optimized product bundles.

In the example system shown in FIG. 4, the installer system 408 includes a product flow tracking engine 410 and a product presentation determination engine 412. In a specific implementation, the product flow tracking engine 410 determines what slot in a product flow to analyze whether a product included in the slot should be presented to a requestor. The product flow tracking engine 410 can move and place an indicator at the corresponding slot in the product flow that it determines should be analyzed as to whether the product included in the corresponding slot should be presented to a requestor. Depending upon implementation-specific or other considerations, the product flow tracking engine 410 can start at the slot in a product flow that includes a product requested by a requestor and continue down the product flow. In an example, the product flow tracking engine 410 can start at a first slot in a product flow and then continue to a second slot in the product flow after it is determined whether to present a product included in the first slot to a requestor and if it is determined to present a product included in the first slot to the requestor, after the product in the first slot is presented to the requestor.

In a specific implementation, the product presentation determination engine 412 functions to determine whether to present a product included in a yield optimized product bundle to a requestor interacting with the yield optimized product bundle. In determining whether to present a product in a yield optimized product bundle, the product presentation determination engine 412 can determine whether to present a product included in a slot in the product determined by the product flow tracking engine 410, e.g. the product included in the a slot in the product flow at which the product flow tracking engine 410 places an indicator. The product flow tracking engine 410 can use product presentation conditions of a product included at a specific slot in a product flow, as determined by the product flow tracking engine 410, to determine whether to present the product to a requestor interacting with a yield optimized product bundle. Additionally, the product presentation determination engine 412 can use requestor device characteristics of the requestor device 404 to determine whether to present a product included in a yield optimized product bundle to a requestor. For example, if product presentation conditions specify to only present a product if a certain web browser is installed on the requestor device 404, and requestor device characteristics indicate that the web browser is not installed on the requestor device 404, then the product presentation determination engine 412 can determine to not present the product to a user of the requestor device 404 interacting with the yield optimized product bundle.

In a specific implementation, the product presentation determination engine 412 functions to determine whether to show another product to a requestor or begin installation of selected product(s). In various implementations, the product presentation determination engine 412 can determine whether to show another product to a request or begin installation of selected product(s) based on installation trigger rules included as part of product presentation conditions for a yield optimized product bundle. For example, if product presentation rules specify to being installation of product(s) after the condition of a maximum amount of product acceptances is achieved, and the product presentation determination engine 412 determines that a requestor has accepted the maximum amount of products in interacting with a product bundle, then the product presentation determination engine 412 can determine to being installation of the selected product(s).

In an example of operation of the example system shown in FIG. 4, the requestor device 404 allows a requestor to interact with a yield optimized product bundle generated by the yield optimized bundle generation system 406. In the example of operation, the product flow tracking engine 410 determines a slot in a product flow to analyze whether a product included in the slot should be presented to the requestor. Further in the example of operation, the product presentation determination engine 412 functions to determine whether to present a product included in a slot in the product flow determined by the product flow tracking engine 410, to the requestor based on product presentation conditions.

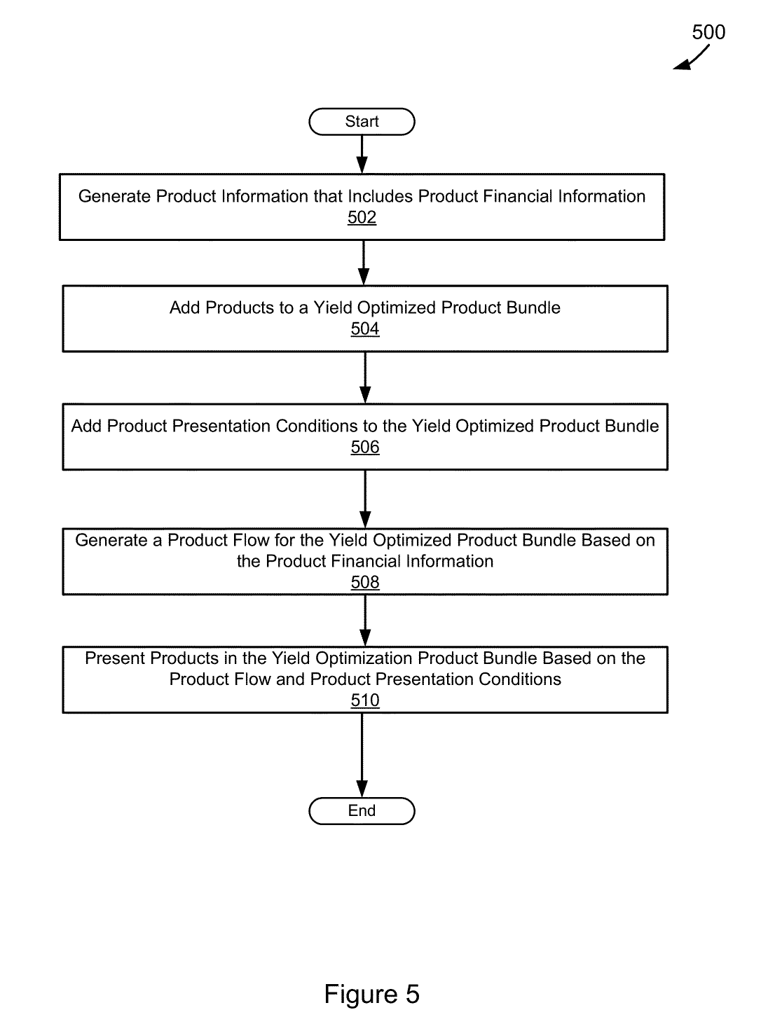

FIG. 5 depicts a flowchart 500 of an example of a method for generating a yield optimized product bundle and providing interaction with the yield optimized product bundle using product financial information. The flowchart 500 begins at module 502, where product information that includes product financial information is generated. Product financial information generated at module 502 can include either or both amount of revenue generated per install for products or amount of revenue generated per offer for products. Product financial information generated at module 502 can be generated using either or both input of entities associated with the yield optimized product bundle and bundle performance data of already created yield optimized product bundles.

The flowchart 500 continues to module 504, where products are added to a yield optimized product bundle 504. In adding products to a yield optimized product bundle, product URLs of the products can be included in the yield optimized product bundle. Depending upon implementation-specific or other considerations, products can be added to a yield optimized product bundle at module 504, based on product information. Further depending upon implementation-specific or other considerations, products can be added to a yield optimized product bundle at module 504, based on products requested to be downloaded by a user of a requestor device.

The flowchart 500 continues to module 506, where product presentation conditions of product added to the yield optimized product bundle at module 504 are added to the yield optimized product bundle. Product presentation conditions added to the yield optimized product bundle at module 506 can be used to determine whether to present a product to a requestor interacting with the yield optimized product bundle. For example, product presentation conditions can specify to only present a product if a specific web browser is present on a requestor device. Product presentation conditions can be generated based on product information generated at module 502.

The flowchart 500 continues to module 508, where a product flow for the yield optimized product bundle is generated based on product financial information generated at module 502. A product flow generated at module 508 includes slots to which products are added. Slots of a product flow generated at module 508 can be used in determining an order in which it is determined whether to present products to a requestor interacting with the yield optimized product bundle. Products can be added into slots in the product flow based on either or both amount of revenue generated per install for the products or amount of revenue generated per offer for the products. For example, products can be added to a product flow at module 508, in descending order from highest to lowest amount of revenue generated per install for the products or amount of revenue generated per offer for the products.

The flowchart 500 continues to module 510, where products in the yield optimized product bundle are presented to a requestor interacting with the yield optimized product bundle based on the product flow and product presentation conditions. In presenting products to a requestor interacting with the yield optimized product bundle at module 510, it can be determined whether to present a product to the requestor based on the product presentation conditions. Further in presenting product to a requestor at module 510, the order in which it is determined whether to present products to a requestor can be determined based on the product flow. For example, it can first be determined whether to present a first product in a first slot in the product flow to the requestor, after which it can be determined whether to present a second product in a second slot in the product flow to the requestor.

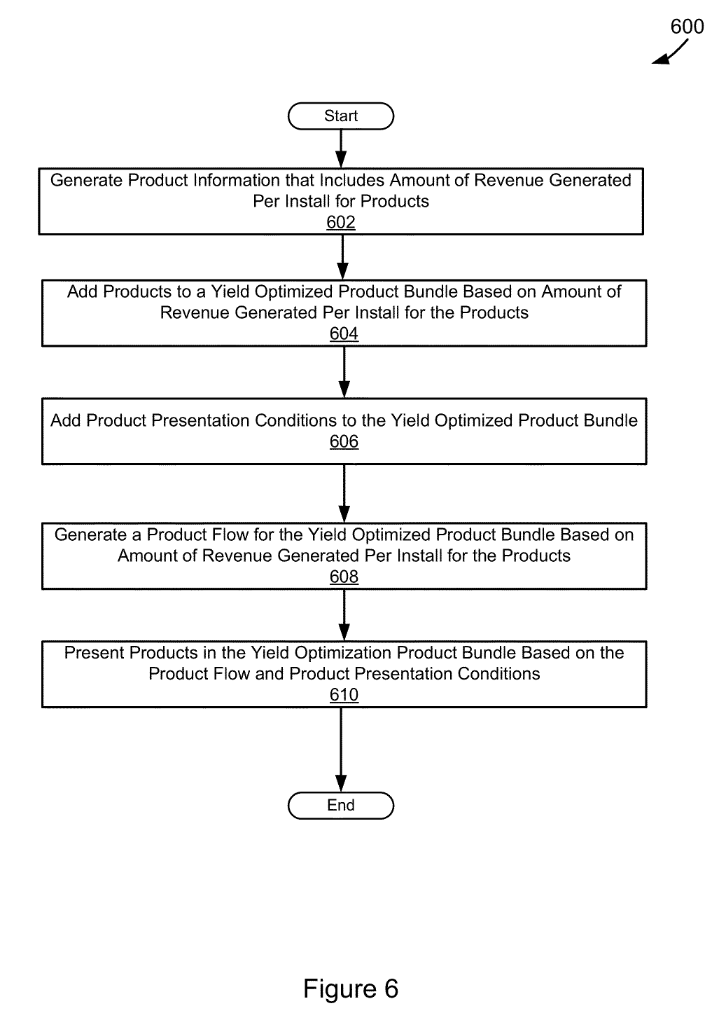

FIG. 6 depicts a flowchart 600 of an example of a method for generating a yield optimized product bundle and providing interaction with the yield optimized product bundle using amount of revenue generated per install for products. The flowchart 600 begins at module 602, where product information that includes amount of revenue generated per install for products is generated. An amount of revenue generated per install for products can be generated using input received from entities associated with the yield optimized product bundle. For example, input received from entities associated with the yield optimized product bundle can include payout rates of advertisers or distributors of the yield optimized product bundle. The payout rates of advertisers or distributors of the yield optimized product bundle can be used to determine an amount of revenue generated per install for products.

The flowchart 600 continues to module 604, where products are added to a yield optimized product bundle based on amounts of revenue generated per install for the products. For example, at module 604, products with the highest amount of revenue generated per install can be added to a yield optimized product bundle. In adding product to a yield optimized product bundle at module 604, product URLs of the product can also be included in the yield optimized product bundle. Depending upon implementation-specific or other considerations, a product that is requested by a user of a requestor device can be added to a yield optimized product bundle along with products that are added based on amount of revenue generated per install for the products.

The flowchart 600 continues to module 606, where product presentation conditions of products added to the yield optimized product bundle at module 604 are added to the yield optimized product bundle. Product presentation conditions added to the yield optimized product bundle at module 606 can be used to determine whether to present a product to a requestor interacting with the yield optimized product bundle. For example, product presentation conditions can specify to only present a product if a specific web browser is present on a requestor device. Product presentation conditions can be generated based on product information generated at module 602. For example, product presentation conditions can be generated based on product operational information that is included as product information generated at module 602.

The flowchart 600 continues to module 608, where a product flow for the yield optimized product bundle is generated based on amount of revenue generated per install for the products added to the yield optimized product bundle. A product flow generated at module 608 includes slots to which products are added. Slots of a product flow generated at module 608 can be used in determining an order in which it is determined whether to present products to a requestor interacting with the yield optimized product bundle. Products can be added to slots of a product flow at module 608, in descending order from highest to lowest amount of revenue generated per install for the products.

The flowchart 600 continues to module 610, where products in the yield optimized product bundle are presented to a requestor interacting with the yield optimized product bundle based on the product flow and product presentation conditions. In presenting products to a requestor interacting with the yield optimized product bundle at module 610, it can be determined whether to present a product to the requestor based on the product presentation conditions. Further in presenting product to a requestor at module 610, the order in which it is determined whether to present products to a requestor can be determined based on the product flow. For example, it can first be determined whether to present a first product in a first slot in the product flow to the requestor, after which it can be determined whether to present a second product in a second slot in the product flow to the requestor.

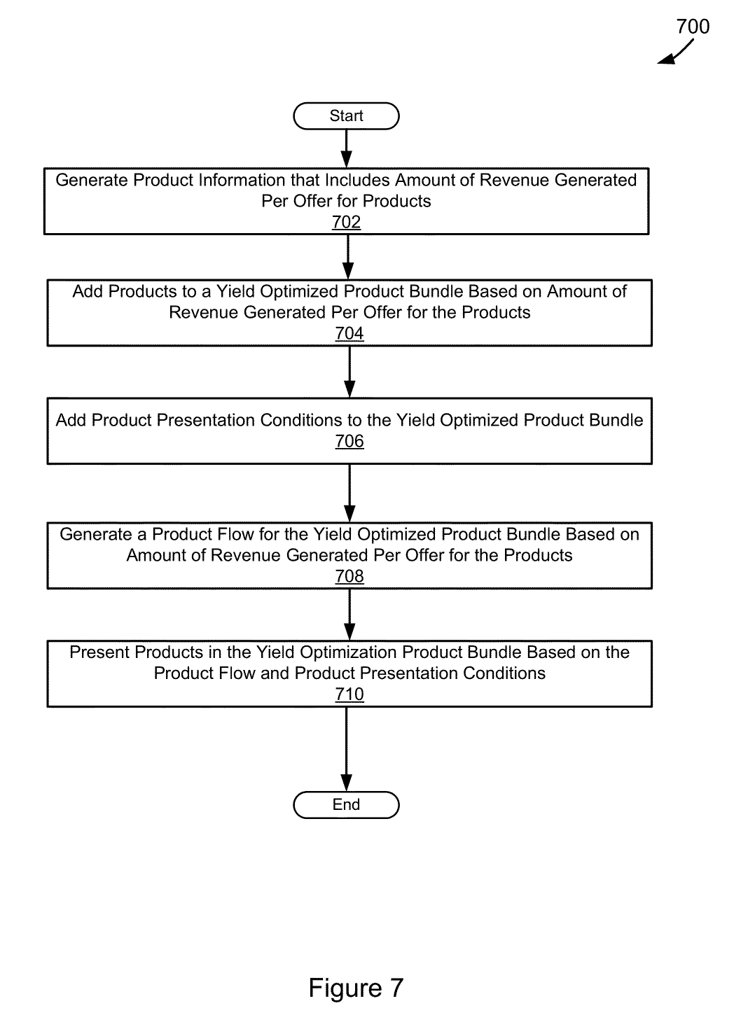

FIG. 7 depicts a flowchart 700 of an example of a method for generating a yield optimized product bundle and providing interaction with the yield optimized product bundle using amount of revenue generated per offer for products. The flowchart 700 begins at module 702, where product information that includes amount of revenue generated per offer for products is generated. An amount of revenue generated per offer for products can be generated using an amount of revenue generated per install for products and rates at which products are installed after presented to a requestor interacting with a yield optimized product bundle. Rates at which products are installed can be determined from bundle performance data.

The flowchart 700 continues to module 704, where products are added to a yield optimized product bundle based on amounts of revenue generated per offer for the products. For example, at module 704, products with the highest amount of revenue generated per offer can be added to a yield optimized product bundle. In adding product to a yield optimized product bundle at module 704, product URLs of the product can also be included in the yield optimized product bundle. Depending upon implementation-specific or other considerations, a product that is requested by a user of a requestor device can be added to a yield optimized product bundle along with products that are added based on amount of revenue generated per offer for the products.

The flowchart 700 continues to module 706, where product presentation conditions of products added to the yield optimized product bundle at module 704 are added to the yield optimized product bundle. Product presentation conditions added to the yield optimized product bundle at module 706 can be used to determine whether to present a product to a requestor interacting with the yield optimized product bundle. For example, product presentation conditions can specify to only present a product if a specific web browser is present on a requestor device. Product presentation conditions can be generated based on product information generated at module 702. For example, product presentation conditions can be generated based on product operational information that is included as product information generated at module 702.

The flowchart 700 continues to module 708, where a product flow for the yield optimized product bundle is generated based on amount of revenue generated per offer for the products added to the yield optimized product bundle. A product flow generated at module 708 includes slots to which products are added. Slots of a product flow generated at module 708 can be used in determining an order in which it is determined whether to present products to a requestor interacting with the yield optimized product bundle. Products can be added to slots of a product flow at module 708, in descending order from highest to lowest amount of revenue generated per offer for the products.

The flowchart 700 continues to module 710, where products in the yield optimized product bundle are presented to a requestor interacting with the yield optimized product bundle based on the product flow and product presentation conditions. In presenting products to a requestor interacting with the yield optimized product bundle at module 710, it can be determined whether to present a product to the requestor based on the product presentation conditions included in the yield optimized product bundle. Further in presenting product to a requestor at module 710, the order in which it is determined whether to present products to a requestor can be determined based on the product flow. For example, it can first be determined whether to present a first product in a first slot in the product flow to the requestor, after which it can be determined whether to present a second product in a second slot in the product flow to the requestor.

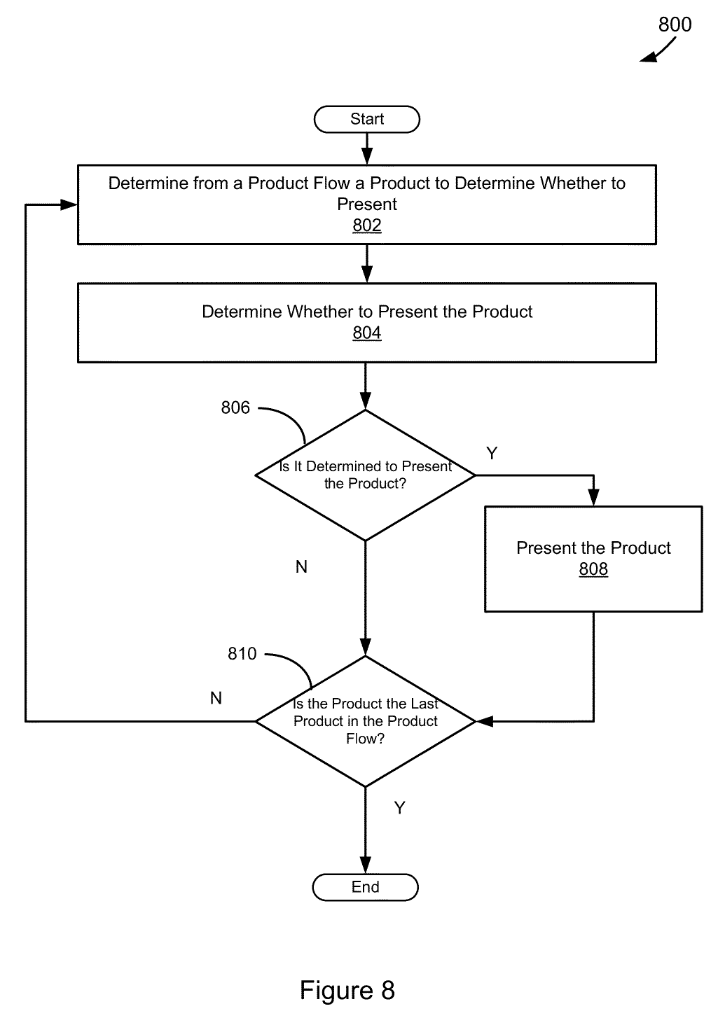

FIG. 8 depicts a flowchart 800 of an example of a method for presenting products in a yield optimized product bundle to a requestor as the requestor interacts with the yield optimized product bundle. The flowchart 800 begins at module 802, where it is determined, from a product flow included in the yield optimized product bundle, a product to determine whether to present to a requestor interacting with the yield optimized product bundle. Products can be determined from the product flow in the sequential order of slots within a product flow. For example, if a product flow has a first product in a first slot, a second product in a second slot, and a third product in a third slot, then the first product can be determined first, then the second product, and then the third product.

The flowchart 800 continues to module 804, where it is determined whether to present the product determined at module 802 to a requestor interacting with a yield optimized product bundle. Product presentation conditions associated with the product can be used to determine whether to present the product to a requestor interacting with a yield optimized product bundle. Additionally, requestor device characteristics of a requestor device that is used by a user to interact with the yield optimized product bundle can also be used to determine whether to present the product.

The flowchart 800 continues to decision point 806, where it is determined whether it was determined to present the product at module 804. If it is determined to present the product, then the flowchart 800 continues to module 808 where the product is presented to the requestor. In presenting the product to the requestor, a product URL can be presented to the requestor, through which the requestor can download the product. After module 808 the flowchart 800 continues to decision point 810. Similarly, if it is determined at decision point 806 that it was determined to not present the product to the requestor, then the flowchart 800 continues to decision point 810.

At decision point 810, it is determined if the product is the last product in the product flow, or if there are any remaining products in the product flow. If it is determined that there are no more products in the product flow or that the product is the last product in the product flow, then the flowchart 800 ends. If it is determined that there are more products in the product flow or that the product is not the last product in the product flow, then the flowchart 800 continues back to module 802 where a new product is determined from the product flow. Depending upon implementation-specific or other considerations, the new product can be the product in the next slot in the product flow.

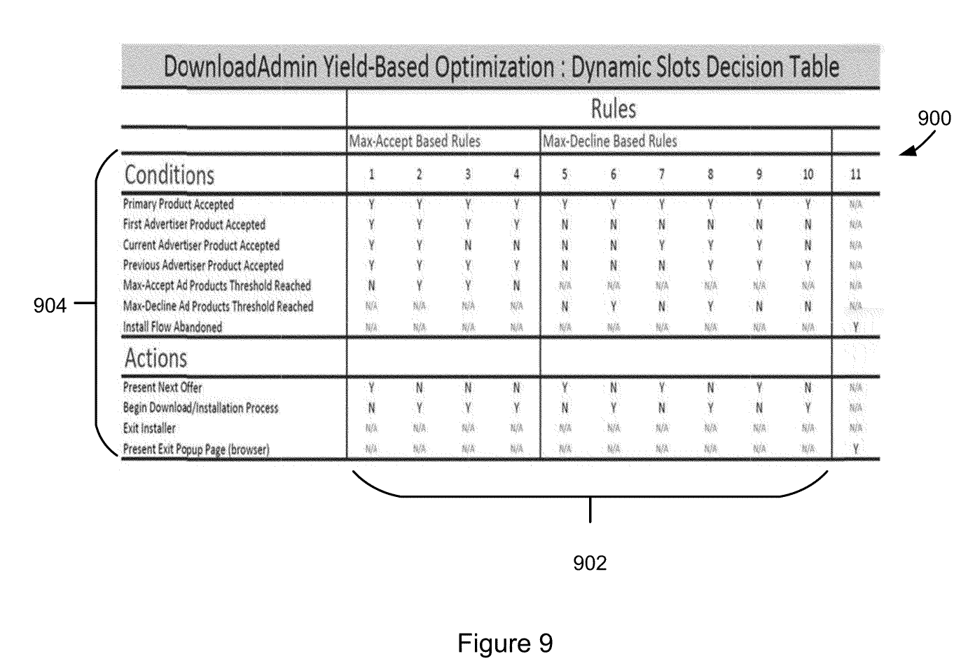

FIG. 9 depicts a table 900 of an example of installation trigger rules 902. The installation trigger rules 902 include conditions 904 used to determine whether or not to begin installation of products selected by a requestor through a product bundle.

In a specific implementation, a trigger rule includes not presenting a next product and triggering installation of accepted products if a requestor accepts a primary product, accepts a first displayed product, accepts a currently displayed product, accepts a previously displayed product, and a maximum number of accepted products threshold has been reached.

In a specific implementation, a trigger rule includes not presenting a next product and triggering installation of accepted products if a requestor accepts a primary product, accepts a first displayed product, rejects a currently displayed product, accepts a previously displayed product, and a maximum number of accepted products threshold has been reached.

In a specific implementation, a trigger rule includes not presenting a next product and triggering installation of accepted products if a requestor accepts a primary product, accepts a first displayed product, rejects a currently displayed product, accepts a previously displayed product, and a maximum number of accepted products threshold has not been reached.

In a specific implementation, a trigger rule includes presenting a next product and not triggering installation of accepted products if a requestor accepts a primary product, rejects a first displayed product, rejects a currently displayed product, rejects a previously displayed product, and a maximum number of declined products threshold has not been reached.

In a specific implementation, a trigger rule includes not presenting a next product and triggering installation of accepted products if a requestor accepts a primary product, rejects a first displayed product, rejects a currently displayed product, rejects a previously displayed product, and a maximum number of declined products threshold has been reached.

In a specific implementation, a trigger rule includes presenting a next product and not triggering installation of accepted products if a requestor accepts a primary product, rejects a first displayed product, accepts a currently displayed product, rejects a previously displayed product, and a maximum number of declined products threshold has not been reached.

In a specific implementation, a trigger rule includes not presenting a next product and triggering installation of accepted products if a requestor accepts a primary product, rejects a first displayed product, accepts a currently displayed product, accepts a previously displayed product, and a maximum number of declined products threshold has been reached.

In a specific implementation, a trigger rule includes presenting a next product and not triggering installation of accepted products if a requestor accepts a primary product, rejects a first displayed product, accepts a currently displayed product, accepts a previously displayed product, and a maximum number of declined products threshold has not been reached.

In a specific implementation, a trigger rule includes not presenting a next product and triggering installation of accepted products if a requestor accepts a primary product, rejects a first displayed product, rejects a currently displayed product, accepts a previously displayed product, and a maximum number of declined products threshold has not been reached.

In a specific implementation, a trigger rule includes presenting a next product and not triggering installation of accepted products if a requestor accepts a primary product, accepts a first displayed product, accepts a currently displayed product, accepts a previously displayed product, and a maximum number of accepted products threshold has not been reached.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
generating product information including product financial information for a plurality of products;
generating product presentation conditions for the plurality of products;
determining products classified into different categories of the plurality of products to add to a yield optimized product bundle;
adding the products and product presentation conditions for the products to the yield optimized product bundle;
organizing the products into a single product flow based on the product financial information;
determining whether to present the products based on the product presentation conditions, an order in which it is determined whether to present the products based on the product flow.

2. The method of claim 1, wherein the product financial information includes amount of revenue generated per install for the products.

3. The method of claim 1, wherein the product financial information includes amount of revenue generated per offer for the products.

4. The method of claim 1, wherein generating product information including product financial information for a plurality of products comprises:
determining a rate at which the products are downloaded after being presented in product bundles from bundle performance data;
determining amount of revenue generated per install of the products;
determining amount of revenue generated per offer of the products using the rate at which the products are downloaded after being presented in the product bundles and the amount of revenue generated per install of the products.

5. The method of claim 2, wherein the products are added into product slots in the single product flow in an order from highest to lowest amount of revenue generated per install for the products.

6. The method of claim 3, wherein the products are added into products slots in the single product flow in an order from highest to lowest amount of revenue generated per offer for the products.

7. The method of claim 1, wherein the products classified into different categories are determined from the plurality of products based on amount of revenue generated per install of products of the plurality of products.

8. The method of claim 1, wherein the products classified into different categories are determined from the plurality of products based on amount of revenue generated per offer of products of the plurality of products.

9. The method of claim 1, wherein the product information includes product operational information that is used to generate the product presentation conditions.

10. The method of claim 1, the products added to the yield optimized product bundle include a product requested by a requestor interacting with the yield optimized product bundle.

11. The method of claim 1, wherein the product presentation conditions for the products include installation trigger rules used to determine whether to display a next product or trigger installation of at least one accepted product.

12. A system comprising:
a product financial information determination engine configured to generate product financial information for a plurality of products;
a condition system configured to generate product presentation conditions for the plurality of products;
a product inclusion engine configured to:
determine products classified into different categories of the plurality of products to add to a yield optimized product bundle;
add the products to the yield optimized product bundle;
a product conditions inclusion engine configured to add product presentation conditions for the products to the yield optimized product bundle;
a product flow determination engine configured to organize the products into a single product flow based on the product financial information;
an installer system configured to determine whether to present the products based on the product presentation conditions, an order in which it is determined whether to present the products based on the product flow.

13. The system of claim 12, wherein the product financial information includes amount of revenue generated per install for the products.

14. The system of claim 12, wherein the product financial information includes amount of revenue generated per offer for the products.

15. The system of claim 12, wherein the product financial information determination engine is further configured to:
determine a rate at which the products are downloaded after being presented in product bundles from bundle performance data;
determine amount of revenue generated per install of the products;
determine amount of revenue generated per offer of the products using the rate at which the products are downloaded after being presented in the product bundles and the amount of revenue generated per install of the products.

16. The system of claim 13, wherein the products are added into product slots in the single product flow in an order from highest to lowest amount of revenue generated per install for the products.

17. The system of claim 14, wherein the products are added into products slots in the single product flow in an order from highest to lowest amount of revenue generated per offer for the products.

18. The system of claim 12, wherein the products classified into different categories are determined from the plurality of products based on amount of revenue generated per install of products of the plurality of products.

19. The system of claim 12, wherein the products classified into different categories are determined from the plurality of products based on amount of revenue generated per offer of products of the plurality of products.

20. The system of claim 12, wherein the product information includes product operational information that is used to generate the product presentation conditions.

21. The system of claim 12, wherein the product presentation conditions for the products include installation trigger rules used to determine whether to display a next product or trigger installation of at least one accepted product.

22. A system comprising:
means for generating product information including product financial information for a plurality of products;
means for generating product presentation conditions for the plurality of products;
means for determining products classified into different categories of the plurality of products to add to a yield optimized product bundle;
means for adding the products and product presentation conditions for the products to the yield optimized product bundle;
means for adding the products into a single product flow based on the product financial information;
means for determining whether to present the products based on the product presentation conditions, an order in which it is determined whether to present the products based on the product flow.
